(19) United States
(12) Patent Application Publication
(10) Pub. No.: US 2007/0218210 A1
(43) Pub. Date: Sep. 20, 2007

(54) Protective layer against shaped charges

(76) Inventors: Urs Althaus, Gunten (CH); Rene Knobel, Aarau (CH)

Correspondence Address: SCHWEITZER CORNMAN GROSS & BONDELL LLP, 292 MADISON AVENUE - 19th FLOOR, NEW YORK, NY, 10017, US

(21) Appl. No.: 11/478,032

(22) Filed: Jun. 29, 2006

Related U.S. Application Data
(63) Continuation of application No. PCT/CH03/00851, filed on Dec. 29, 2003.

(51) Int. Cl. B05D 7/00

(52) U.S. Cl. 427/407.1

(57) ABSTRACT

A protective layer for the protection of armoured objects includes a layer comprised solely of a polyurethane elastomer with a Shore A hardness of 3 to 6 and a thickness of 16 to 35 mm. The polyurethane elastomer layer is formed by combining 100 wt percent of a polyols-based component with 50 wt percent of an isocyanates-based component under a pressure of 100-160 mm and ejecting the blend through an enlarged nozzle with respect to the component supply lines into molds at a thickness of 16-35 mm.

This application is a continuation of PCT/CH2003/000851 filed Dec. 29, 2003.

The present invention relates to a protective layer for the protection of armoured objects, such as military vehicles and to a method for fabricating such a layer.

### BACKGROUND OF THE INVENTION

It is known (DE 688526) to provide armour with pointed disrupting elements which disrupt the trajectory of projectiles and thereby protect the object. The same construction can also act against free-falling shaped charges (hollow charges) because an element which penetrates the cavity of the metal liner disrupts or even prevents the formation of a hollow-charge jet.

Among other things, it is known from FR-A1-2 771 490 to glue a layer of polyurethane to the object to be protected and to apply a further layer of foamed rubber with a thickness of 20 mm to 100 mm over the top. A rigid outer covering is provided for mechanically protecting the two layers. The liner of a hollow charge striking this layer pierces the covering, with the result that the resilient layer of foamed rubber can swell up and penetrate the interior of the liner before the hollow-charge jet is formed.

Disadvantages of such constructions are that a foil or metallic layer prestressed in some form has to act on the porous foamed rubber so that the latter sufficiently greatly penetrates the interior of the liner after the piercing action. The multilayered structure is costly to manufacture and, owing to its soft intermediate layers, is not mechanically sufficiently resistant for mobile objects and military applications. When struck by branches, fired at by conventional weapons, etc., the outer layers can be damaged or dented so that they can no longer penetrate the interior of a hollow charge. In addition, it must be expected that the piercing action, which is necessary for operation, might not take place in the outer covering because the latter forms a coherent surface and deflects inwards.

It is therefore an object of the present invention to provide a robust and weather-resistant protective layer which withstands impacts and other mechanical stresses and, with a minimal layer thickness, disrupts free-falling hollow charges so that they cause no or only minimal damage to the object to be protected. Such a protective layer should also be applied and be able to be used with reactive armour (Explosive Reactive Armour or ERA) without impairing the protective effect of the latter, which acts against more highly accelerated hollow charges. The invention should also be able to be used to retrofit existing vehicle structures without restricting mobility and/or without having to accept other disadvantages. A vehicle (tank, all-terrain vehicle, etc.) provided with a protective layer must also be tread-resistant, i.e. it must also be possible to walk on the vehicle with heavy boots without causing damage.

A further object of the invention is to provide a method of producing a protective layer according to the invention that is simplified in relation to known methods. Any damage to the layer caused by vehicle operation and general use, e.g. in the case of a tank, should be reparable in the field without special tools or specific technical knowledge.

### BRIEF DESCRIPTION OF THE INVENTION

The foregoing and other objects are met by a protective layer of the present invention that comprises a polyurethane elastomer layer with a Shore A hardness of 3 to 6 and a thickness of between 16 and 35 mm. The elastomer is produced from a first polyols-based component mixed with a second, isocyanates component under a pressure of between 100 and 160 bar. The blend is cast into molds through a nozzle with an enlarged cross-section with reference to the supply lines for the components.

The protective layer, which manifests itself as a single layer, can easily be processed and applied to any surface. It dispenses with the incorporation of reinforcements, inert bodies and the like. A massive layer or a foil comprising another material and covering the entire surface can likewise be omitted.

The physical properties of the layer produce an optimum protective effect against bombardment by hollow charges with percussion fuses, which typically strike a target relatively slowly (50 m/s to 150 m/s).

A free-falling hollow charge, as occurs in bomblets, has a characteristic speed of approximately 60 m/s to 100 m/s on striking the protective layer, and has a relatively small mass. In contrast, hollow-charge projectiles are fired at up to four times the speed of sound and have a large mass, with the result that reactive armour (so-called ERA box) underneath the protective layer can become fully effective.

This means in practice that bombardment by canister bombs (bomblets) is “intercepted” e.g. on a tank with roof protection by the invention. If further bombardment by a modern tandem hollow charge occurs in the same region, the jet of the precharge pierces the protective layer, undergoes a slight reduction in power owing to the protective layer arranged in front, and initiates the ERA box in the usual manner. Accordingly, the protective layer can be partially provided as a supplement to existing protective measures and be adapted to the expected enemy action, i.e. it can serve principally as roof protection.

The protective layer is insensitive to impacts and the like; minor local damage is “self-healing” owing to the high resilience of the layer; dents do not form.

The method of the invention characterises the manufacture of molded plates as are required for protective layers. The method also allows adaptation to irregularities and/or projections, depressions, etc. on the surface to be protected. 100 wt % of a polyols-based component A is combined with a 50% wt % counter-current introduced isocyanates-based component B under a pressure of 100-160 bar and ejecting the blend through a nozzle of increased cross-section with respect to supply lines for the components into a casting mold at a thickness of 16-35 mm.

A layer with a weight per unit value of 0.9-1.1 g/cm³, offers optimum penetration resistance against bomblets, such as those which are scattered from canister bombs or canister projectiles or are discharged over the target. The material penetrating the cavity of the liner of the hollow charge prevents the effective formation of the jet and simultaneously protects the underlying surface from material effects.

By incorporating colorants into the layer, permanent camouflage and visual adaptation to the usual colours of military vehicles can be achieved. The addition of UV stabilizers can provide protection against ultraviolet radiation and prevents decomposition of the protective layer. A protective lacquer can provide mechanical protection against abrasion and prevents the penetration of any chemicals present, such as fuels, lubricants, etc.

It is advantageous to glue the protective layer directly to the surface of the object to be protected. However, it is also possible to glue or otherwise adhere it to additional protective plates. An intermediate layer of insulating material can provide thermal insulation and is advisable in particular in the case of vehicles exposed to strong sunshine, especially if they have dark surfaces.

To avoid blow-off effects under bombardment, it is recommended to use polyurethane with a closed pore construction.

Accurately shaped surfaces on high-density layers can be achieved by heating larger components and molds to above room temperature, and then cooling the cast layer to room temperature. Processing temperatures for the components and mold between 60 and 80° C., and preferably 70° C., have proved satisfactory.

Optimum coloration and stabilization of the protective layer can be achieved by adding the colorants or stabilizers to at least one of the components.

Vigorously stirring the two components such as by mechanical agitation and homogenization before processing has proved highly advantageous.

Spray coating of the casting after cooling to room temperature by a further coating the component mixture heated to above room temperature can provide mechanical sealing of the surface. Spraying of the surface with a UV-resistant lacquer can considerably extend the life of the protective layer. Such spraying can be in addition to spraying with a sealing coat.

Treating the layer surface with an abrading material, such as quartz sand, increases its non-slip property and can improve its abrasion resistance.

Treatment of the surface of the object to which the layer is to be applied by roughening and degreasing, followed by application of a two-component epoxide resin, has proved highly successful to adhere the layer to the object.

Armoured vehicles in particular require multi-contour adaptation of the protective layer to their geometry and the gap-free joining of individual cut edges. Use of water-jet cutting methods, and particularly abrasive cutting methods, excel in this respect.

### BRIEF DESCRIPTION OF THE DRAWINGS

Illustrative embodiments of the invention will be described in the following detailed disclosure, with reference to the annexed drawings, wherein:

FIG. 1 is a simplified view of an armoured personnel carrier provided with roof protection in accordance with the invention;

FIG. 2 is a sectional view of a characteristic structure of a protective layer of the invention;

FIG. 3 is a section view of a variant of a protective layer of the invention with additional thermal insulation; and

FIG. 4 is a sectional view of a domed roof hatch incorporating a protective layer of the invention.

### DETAILED DESCRIPTION OF THE INVENTION

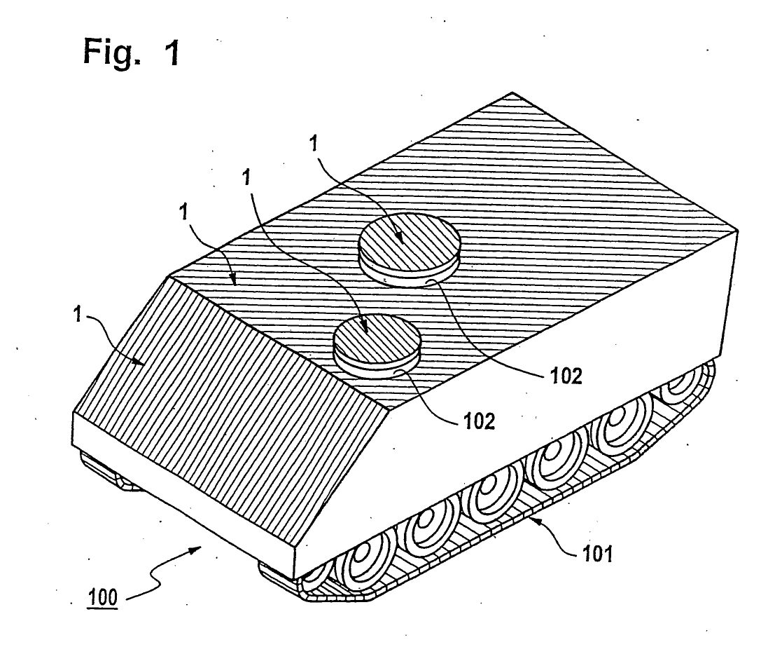

In FIG. 1, an armoured personnel carrier known per se is designated by 100, and its caterpillar drive by 101. Roof protection according to the invention, comprising protective layers 1 in the form of plates arranged in rows, is shown by hatching and extends over the entire vertical projection surface of the vehicle, including roof hatches (entry hatches) 102.

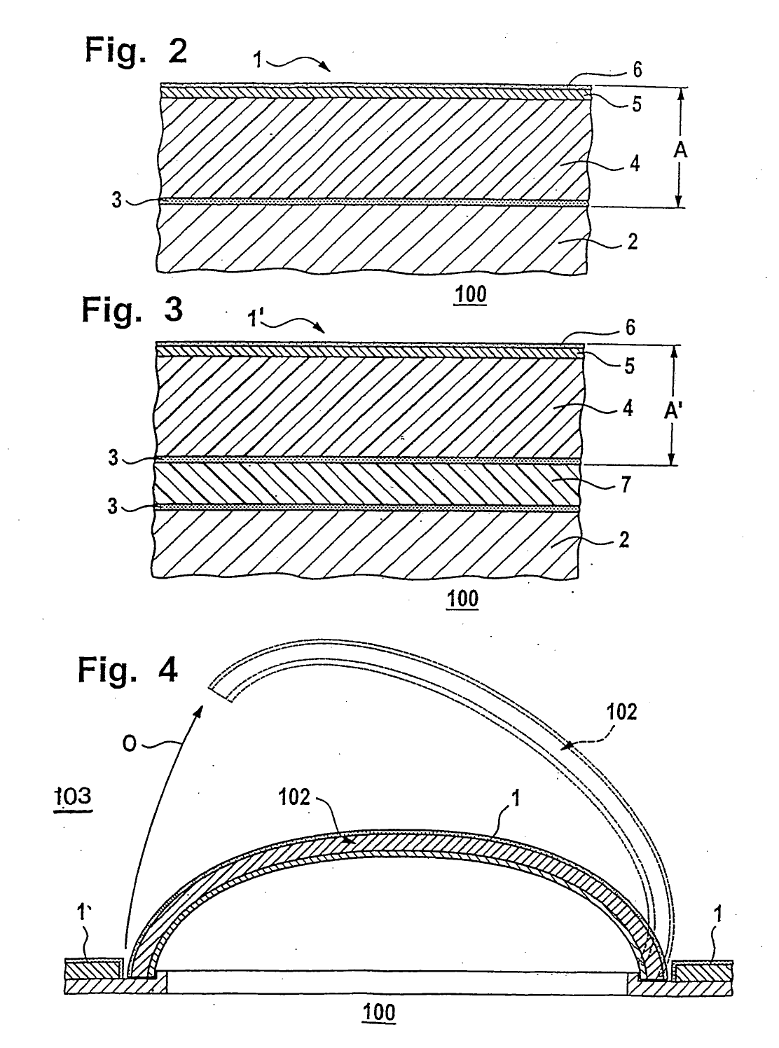

FIG. 2 shows the characteristic layered structure of a first variant of a protective layer 1 of the invention. Protective layer 1 consists of individual layers which are built up on the metal surface 2 of the tank 100. An elastomeric layer 4 of polyurethane with a Shore A hardness of 4, a tensile strength of 0.5 N/mm², an elongation at rupture of 240% and a weight per unit volume of 1.0 g/cm³ is applied to an adhesive layer 3 of epoxide resin (Araldit 20/11, Ciba Spezialitätenchemie AG, CH-4057 Basel).

All the measured values were determined according to DIN 53 505 after test plates had been stored for 7 days.

In FIG. 2, the protective layer comprises two further coatings or layers. Coating 5 is a polyurethane spray coating with a weight per unit area of 220 g/m² (Anti Rust, Elastogran GmbH, D-49440 Lemförde). This is intended to close casting pores (small holes) and increases the mechanical and chemical resistance of the underlying elastomeric layer 4 to which the coating 5 bonds. A lacquer coating 6 against UV radiation with a weight per unit area of 60 g/m² (supplier Tonet AG, CH-4657 Dullikon) overlies the coating 5, and is recommended.

The elastomeric layer 4 is cast in plate form. The two coatings 5 and 6 are then applied in a known manner. After being stored for several days at factory temperature (23° C.), the plates forming the protective layer 1 are glued together at their edges and optionally cut such as by means of a water jet, and adapted to the specific contours of the vehicle to which they are to be applied.

The composite layer has a thickness A of 22 mm.

A variant 1′ of the same layered structure can be seen in FIG. 3. In addition, a soft elastomeric layer 7 can be seen here, which has closed pores and provides thermal insulation to the underlying surface 2.

The elastomeric layer 4 may be produced in a commercial high-pressure polyurethane plant (Isotherm AG, Industriestrasse 6, CH-3661 Uetendorf; model PSM 3000). 100 wt. % of a polyols-based component under a pressure of 100 bar to 160 bar, preferably 140 bar, is mixed with 50 wt. % of an isocyanate-based component B in countercurrent at the same pressure in a chamber. The mixture issuing from the mixing chamber is cast into molds via a nozzle with a cross-section increased by at least 100% in relation to the supply lines for the two components, wherein the layer thickness is set at 16 mm to 30 mm, preferably 22 mm.

Commercially available components as known in the art, such as described in detail in DE-A1-101 38 132 are used as starting materials (Elastocoate® C6255/100, variant 6255-103 made by Elastogran GmbH, D-49440 Lemförde). The associated physical data at 25° C. are:

component A (polyols)=1.05 g/cm³, viscosity=1.1 mPa; component B (isocyanates)=1.100 g/cm³, viscosity 2.700 mPa. The preferred processing temperature is 70° C. It is recommended to preheat the casting molds to the same temperature.

The spray application of the coating 5 is also carried out as known in the art, such as by means of a high-pressure PUR plant (Isotherm AG, Industriestrasse 6, CH-3661 Uetendorf; model PSM 700). To apply the UV protective coating 6, a conventional low-pressure spray gun is used.

The addition of UV stabilisers to at least one component A or B before processing has proved successful. Coloration with generally known coloured pastes is also possible.

Incorporation of a thermal insulation layer into the protective layer construction is depicted in FIG. 3.

The embodiment according to FIG. 3 is particularly advantageous for camouflaged (dark) vehicles which are subjected to relatively long periods of insulation. The thermal insulating layer 7, known per se, preferably comprises a closed pore elastomer. In this case, the layer thickness A′ of the protective layer portion 1′ can be reduced to 16 mm, since this penetrates impacting hollow charges, and is followed by the likewise resilient layer 7. The thickness of the insulating layer 7 can be adapted to prevailing thermal and atmospheric conditions, but should not be less than 8 mm in order to ensure that insulation heat is effectively inhibited.

Molded parts may be manufactured according to the invention as a composite protective layer 1 formed of a series of individual plates bent to a specified degree and glued together at their edges under pressure without becoming detached during use at changing operating temperature. Smaller radii can be achieved by dividing the composite surface into segments. The individual protective layer plates, which can be cut by an abrasive water-jet cutting method (machine model Byjet, Bystronic Laser AG, CH-3362 Niederönz), can be glued together seamlessly on the vehicle. FIG. 4 shows a cover 102 of an entry hatch 103, which cover 102 is provided with a single composite large plate comprising a protective layer 1 and can be opened in arrow direction O.

Smaller molded parts can also be adapted to the metal surface 2 by casting.

Practical experiments with bomblets have surprisingly revealed to the skilled person that the effect of their front hollow charge (calibre 40 mm; mass 200 g; impact speed 60 m/s) is reduced by 85% to over 90% by a single layer of polyurethane in accordance with the invention with a thickness of 22 mm. A jet striking the vehicle armour, with only 10% to 15% of the expected rated power in practice produces ineffectiveness in relation to conventional tank protection and also cannot initiate reactive armour. Obviously, the entire layer thickness acts as a disrupting element and simultaneously intercepts the falling bomblets with optimum spring deflection behaviour.

It is possible to provide the underside of the protective layer with cavities in order to save material and weight without impairing its protective effect, although this would require special casting processes.

Self-evidently, the subject matter of the invention is also suitable for stationary installations (buildings), but still satisfies the much higher demands on vehicles for their use in the field.

We claim:

1. A protective layer for the protection of armoured objects, characterized in that the protective layer includes a layer comprised solely of a polyurethane elastomer with a Shore A hardness of 3 to 6 and a thickness of 16 mm to 35 mm.

2. A protective layer according to claim 1, characterized in that the polyurethane layer has a weight per unit volume of 0.9 g/cm³ to 1.1 g/cm³, a tensile strength of 0.4 N/mm² to 0.6 N/mm² and an elongation at rupture of 200% to 300%.

3. A protective layer according to claim 1 or 2, further including at least one colorant.

4. A protective layer according to claim 1 or 2, further including at least one UV stabilizer.

5. A protective layer according to claim 1 or 2, further including a UV protective lacquer coating.

6. A protective layer according to claim 1 or 2, further including an adhesive layer for mounting the protective layer to a surface of the object to be protected.

7. A protective layer according to claim 6, further comprising an intermediate layer of an insulating material between the surface of the object to be protected and the polyurethane layer.

8. A protective layer according to claim 7, characterised in that the insulating material comprises a polyurethane with closed pores.

9. A method for manufacturing a protective layer for the protection of armoured objects comprising the steps of
combining 100 wt % of a polyols-based component A with a counter-current introduced 50% wt % of a isocyanates-based component B under a pressure of 100-160 bar; and
ejecting the combined product through a nozzle having a cross-section at least 100% greater in cross-section than supply lines for the A and B components into a casting mold wherein the thickness of the ejected combined product is between 16 and 35 mm.

10. A method according to claim 9, characterized in that the two components A and B and the casting mold are heated to above room temperature, and in that the cast protective layer is cooled to room temperature and stored for use.

11. A method according to claim 10, characterized in that the two components A and B and the casting mold are heated to between 60° C. to 80° C. before mixing.

12. A method according to claim 10, characterized in that at least one of a UV stabilizer and a colorant is added to at least one of the two components A and B.

13. A method according to claim 9, 10, 11 or 12, characterized in that the two components A and B are mechanically agitated and homogenized before mixing.

14. A method according to claim 11, characterized in that a surface of the cast protective layer, after being cooled to room temperature, is provided with a spray coating of a mixture of the components A and B heated to above room temperature.

15. A method according to claim 14, characterized in that a coating comprising a UV stabilizer is applied to the cast protective layer.

16. A method according to claim 14 or 15, characterized in that an uppermost surface of the cast protective layer is mechanically abraded by a quartz sand material.

17. A method according to claim 9, characterised in that a surface of an object to be protected is roughened, degreased and provided with an epoxide resin adhesive, to which the protective layer is then attached.

18. A method according to claim 9 or 10 further comprising the step of contouring abutting edges of individual elements formed of the protective layer by a water jet cutting method to conform to the geometry of the object to be protected.
